(19) United States
(12) Patent Application Publication
(10) Pub. No.: US 2025/0278014 A1
(43) Pub. Date: Sep. 4, 2025

(54) ADJUSTMENT MODULE, OPTICAL ENGINE MODULE, AND PROJECTION DEVICE

(71) Applicant: Coretronic Corporation, Hsin-Chu (TW)

(72) Inventors: YI-CHANG CHEN, Hsin-Chu (TW); SHENG-YU CHIU, Hsin-Chu (TW)

(21) Appl. No.: 19/063,346

(22) Filed: Feb. 26, 2025

Related U.S. Application Data
(60) Provisional application No. 63/560,791, filed on Mar. 4, 2024.

(30) Foreign Application Priority Data
Apr. 29, 2024 (CN) 2024105324053

(51) Int. Cl. G03B 21/14

(52) U.S. Cl. CPC G03B 21/142

(57) ABSTRACT

An adjustment module, an optical engine module, and a projection device including the adjustment module and optical engine module are disclosed. The projection device comprises a light source module that provides an illumination beam. The optical engine module receives the illumination beam and converts it into an image beam. The adjustment module is positioned between the light source module and the light entry portion of the optical engine module. The light source module is secured to a substrate of the adjustment module. The adjustment module includes the substrate, a first adjustment component, and a second adjustment component. By the first adjustment component, the adjustment module moves the light source module in a first extension direction, and by the second adjustment component, the adjustment module moves the light source module in a second extension direction, thereby aligning the light source module and optical engine module.

### CROSS-REFERENCES

This application claims the priority benefit of U.S. provisional patent application No. 63/560,791, filed Mar. 4, 2024 and Chinese Patent Application Serial Number 2024105324053, filed on Apr. 29, 2024, the full disclosure of which is incorporated herein by reference.

### TECHNICAL FIELD

The present application relates to an adjustment module, an optical engine module, and a projection device.

### DESCRIPTION OF RELATED ART

The imaging principle of a projection device involves converting the illumination beam generated by the light source module into an image beam using a light valve. This image beam is then projected onto a screen, a projection surface, or a plane through a lens. Typically, the light valve is configured within the optical engine module of the projection device, necessitating precise alignment between the light source module and the optical engine module to ensure accurate illumination beam entry into the optical engine module. However, existing light source modules and optical engine modules are fixed structures, meaning their alignment is constrained by these fixed structures, thereby increasing the difficulty of achieving precise alignment between the light source module and the optical engine module.

The information disclosed in this DESCRIPTION OF RELATED ART section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE INVENTION

The present application provides an adjustment module, an optical engine module, and a projection device, which can quickly align the light source module and the optical engine module.

Other objectives and advantages of the present application can be further understood from the technical features disclosed in the present application.

To achieve one or part or all of the above objectives or other objectives, an embodiment of the present application proposes a projection device, which includes a light source module, an optical engine module, and a projection lens. The light source module provides an illumination beam. The optical engine module is used to receive the illumination beam, and it includes an optical engine module base and an adjustment module. The optical engine module is adapted to convert the illumination beam into an image beam.

A light entry portion of the optical engine module base has a first side wall and a second side wall that are substantially perpendicular to each other. The first side wall has a first through hole, and the second side wall has a second through hole. The light entry opening of the light entry portion is located at the intersection of the first extension direction of the first through hole and the second extension direction of the second through hole. The light entry opening is adapted to allow the illumination beam from the light source module to pass through.

The adjustment module is located between the light source module and the light entry portion of the optical engine module base. The adjustment module has a substrate, a first adjustment component, and a second adjustment component. The light source module is fixed to the substrate of the adjustment module. The substrate has a light transmission port, a first adjustment screw hole, and a second adjustment screw hole. The light transmission opening communicates with the light entry opening. The illumination beam from the light source module is adapted to sequentially pass through the light transmission opening and the light entry opening.

The first adjustment screw hole is adjacent to the first side wall and is located in the first extension direction of the first through hole, and the second adjustment screw hole is adjacent to the second side wall and is located in the second extension direction of the second through hole. The first extension direction is different from the second extension direction.

The first adjustment component includes a first limit piece and a first adjustment element. The first limit piece includes a first opening. The first opening is located in the first extension direction of the first through hole. The first adjustment element passes through the first through hole of the first side wall and threads with the first adjustment screw hole. A first head of the first adjustment element is rotatably positioned between the first limit piece and the first side wall, and the first head is exposed through the first opening of the first limit piece.

The second adjustment component includes a second limit piece and a second adjustment element. The second limit piece includes a second opening. The second opening is located in the second extension direction of the second through hole. The second adjustment element passes through the second through hole of the second side wall and threads with the second adjustment screw hole. A second head of the second adjustment element is rotatably positioned between the second limit piece and the second side wall, and the second head is exposed through the second opening of the second limit piece.

The projection lens is located in a transmission path of the image beam from the optical engine module.

By rotating the first head of the first adjustment element through the first opening, the substrate drives the light source module to move in the first extension direction relative to the first adjustment element. Similarly, by rotating the second head of the second adjustment element through the second opening, the substrate drives the light source module to move in the second extension direction relative to the second adjustment element.

To achieve one or part or all of the above objectives or other objectives, an embodiment of the present application proposes an adjustment module, which is configured at the light entry portion of the optical engine module base. The light entry portion has a first side wall and a second side wall that are substantially perpendicular to each other. The first side wall has a first through hole, and the second side wall has a second through hole. The light entry opening of the light entry portion is located at the intersection of the first extension direction of the first through hole and the second extension direction of the second through hole. The adjustment module includes a substrate, a first adjustment component, and a second adjustment component.

The substrate has a light transmission opening, a first adjustment screw hole, and a second adjustment screw hole. The light transmission opening communicates with the light entry opening. The first adjustment screw hole is adjacent to the first side wall and is located in the first extension direction of the first through hole, and the second adjustment screw hole is adjacent to the second side wall and is located in the second extension direction of the second through hole. The first extension direction is different from the second extension direction.

The first adjustment component includes a first limit piece and a first adjustment element. The first limit piece includes a first opening. The first opening is located in the first extension direction of the first through hole. The first adjustment element passes through the first through hole of the first side wall and threads with the first adjustment screw hole. A first head of the first adjustment element is rotatably positioned between the first limit piece and the first side wall. The first head is exposed through the first opening of the first limit piece.

The second adjustment component includes a second limit piece and a second adjustment element. The second limit piece includes a second opening. The second opening is located in the second extension direction of the second through hole. The second adjustment element passes through the second through hole of the second side wall and threads with the second adjustment screw hole. A second head of the second adjustment element is rotatably positioned between the second limit piece and the second side wall. The second head is exposed through the second opening of the second limit piece.

By rotating the first head of the first adjustment element through the first opening, the substrate moves in the first extension direction relative to the first adjustment element. Similarly, by rotating the second head of the second adjustment element through the second opening, the substrate moves in the second extension direction relative to the second adjustment element.

To achieve one or part or all of the above objectives or other objectives, an embodiment of the present application proposes an optical engine module for receiving an illumination beam. The optical engine module includes an optical engine module base and an adjustment module.

A light entry portion of the optical engine module base has a first side wall and a second side wall that are substantially perpendicular to each other. The first side wall has a first through hole, and the second side wall has a second through hole. The light entry opening of the light entry portion is located at an intersection of the first extension direction of the first through hole and the second extension direction of the second through hole.

The adjustment module is configured at the light entry portion. The adjustment module includes a substrate, a first adjustment component, and a second adjustment component. The substrate has a light transmission opening, a first adjustment screw hole, and a second adjustment screw hole. The light transmission opening communicates with the light entry opening. The first adjustment screw hole is adjacent to the first side wall and is located in the first extension direction of the first through hole. The second adjustment screw hole is adjacent to the second side wall and is located in the second extension direction of the second through hole. The first extension direction is different from the second extension direction.

The first adjustment component includes a first limit piece and a first adjustment element. The first limit piece includes a first opening. The first opening is located in the first extension direction of the first through hole. The first adjustment element passes through the first through hole of the first side wall and threads with the first adjustment screw hole. A first head of the first adjustment element is rotatably positioned between the first limit piece and the first side wall. The first head is exposed through the first opening of the first limit piece.

The second adjustment component includes a second limit piece and a second adjustment element. The second limit piece includes a second opening. The second opening is located in the second extension direction of the second through hole. The second adjustment element passes through the second through hole of the second side wall and threads with the second adjustment screw hole. A second head of the second adjustment element is rotatably positioned between the second limit piece and the second side wall. The second head is exposed through the second opening of the second limit piece.

By rotating the first head of the first adjustment element through the first opening, the substrate moves in the first extension direction relative to the first adjustment element. Similarly, by rotating the second head of the second adjustment element through the second opening, the substrate moves in the second extension direction relative to the second adjustment element.

Based on the above, the embodiment of the present application has at least one of the following advantages or effects. In the projection device of the present application, the optical engine module includes an optical engine module base and an adjustment module. The adjustment module drives the light source module to move relative to the optical engine module. Thus, during the alignment process, simply adjusting the adjustment module can drive the light source module to move relative to the optical engine module, allowing for quick and accurate alignment of the light source module and the optical engine module without being constrained by their own structures. Additionally, since the alignment between the light source module and the optical engine module can be achieved through the adjustment module, the impact of part tolerances of the light source module and the optical engine module on the illumination beam can be significantly reduced. This reduces the tolerance requirements for parts, thereby lowering the purchase cost of parts.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF DRAWINGS

The accompanying drawings presented herein serve to deepen the understanding of the present application and are an integral part thereof. The illustrative embodiments and their explanations are provided to elucidate the present application and do not impose any undue limitations on it. In the drawings:

FIG. 1 is a block diagram of the projection device according to an embodiment of the present application;

FIG. 2 illustrates a perspective view of the projection device shown in FIG. 1;

FIG. 3 illustrates another perspective view of the projection device shown in FIG. 1;

FIG. 4 illustrates another schematic view of the projection device shown in FIG. 1;

FIG. 5 illustrates yet another perspective view of the projection device shown in FIG. 1;

FIG. 6 illustrates a perspective view of the optical engine module base according to the present application;

FIG. 7 illustrates a perspective view of the adjustment module according to the present application;

FIG. 8 illustrates a partial enlarged schematic view of the adjustment module and the optical engine module base;

FIG. 9 illustrates a cross-sectional view taken along line B-B of FIG. 8;

FIG. 10 illustrates a cross-sectional view taken along line C-C of FIG. 5;

FIG. 11 illustrates another schematic view of FIG. 8 from a different angle;

FIG. 12 illustrates a cross-sectional view taken along line A-A of FIG. 11;

FIG. 13 illustrates a schematic view of an embodiment of the elastic piece according to the present application;

FIG. 14 illustrates a schematic view of the adjustment module including an optical component according to the present application;

FIG. 15 illustrates a schematic view of the adjustment module including a light source dustproof piece according to the present application; and

FIG. 16 illustrates another schematic view of the adjustment module including an optical engine module dustproof piece according to the present application.

### DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

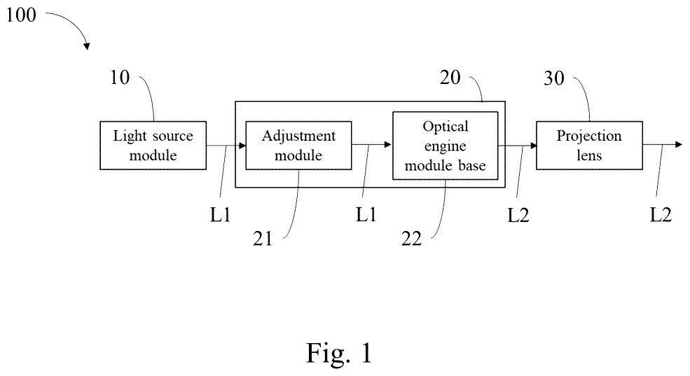

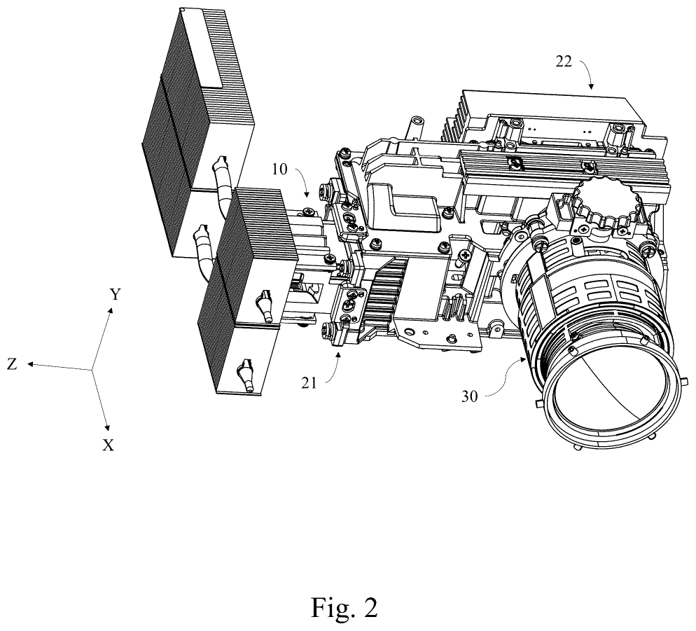

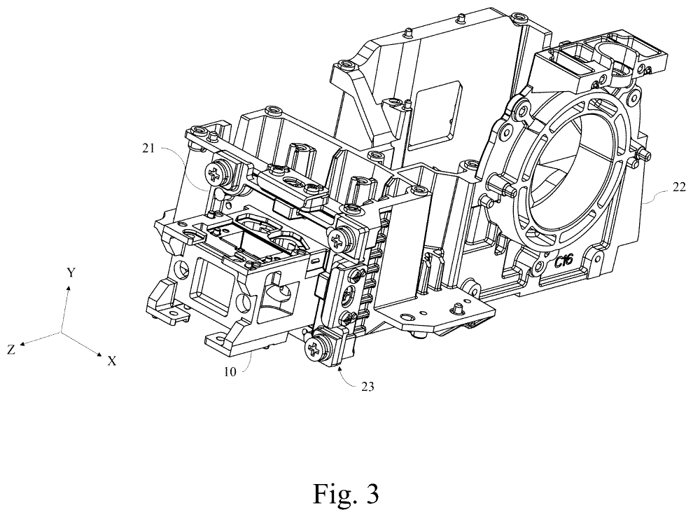

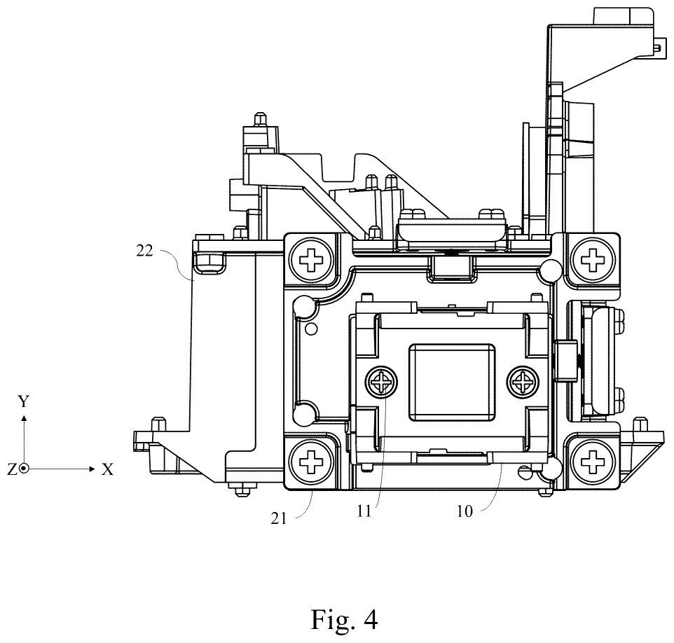

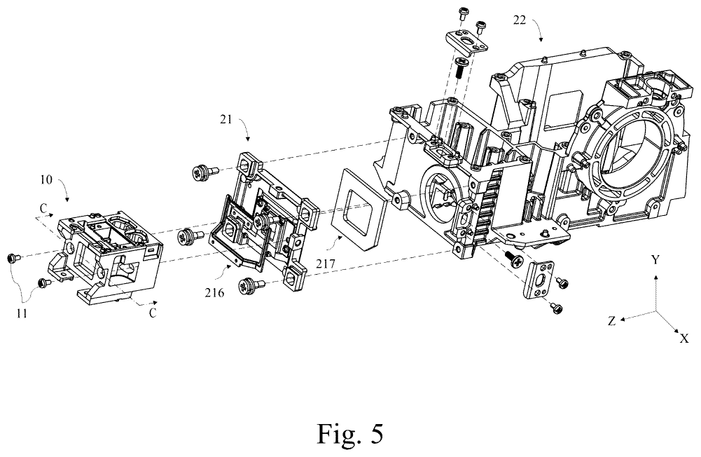

FIG. 1 is a block diagram of the projection device according to an embodiment of the present application. FIG. 2 illustrates a perspective view of the projection device shown in FIG. 1. FIG. 3 illustrates another perspective view of the projection device shown in FIG. 1. FIG. 4 illustrates another schematic view of the projection device shown in FIG. 1. FIG. 5 illustrates yet another perspective view of the projection device shown in FIG. 1. This embodiment of the projection device 100 includes a light source module 10, an optical engine module 20, and a projection lens 30. The light source module 10 is used to provide an illumination beam L1. (The light source module 10 may be composed of at least one light-emitting element, a wavelength conversion element, a light homogenizing element, a filter element, and at least one light guide element to provide light beams with different wavelengths to serve as a source of the illumination beam L1.). The optical engine module 20 is used to receive the illumination beam L1 and provide an image beam L2. The projection lens 30 is located on a transmission path of the image beam L2 from the optical engine module 20. The projection lens 30 is used to receive the image beam L2 from the optical engine module 20 and project the image beam L2. For example, the projection lens 30 can be a combination of one or more optical lenses with diopter, such as a biconcave lens, biconvex lens, concave-convex lens, convex-concave lens, plano-convex lens, and plano-concave lens. In other embodiments, the projection lens 30 can also include planar optical lenses to reflectively project the image beam L2 to a projection target.

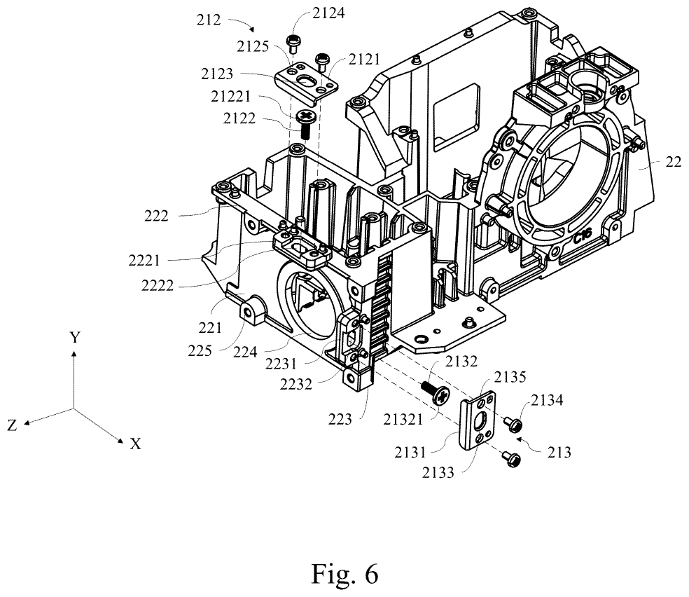

The optical engine module 20 includes an optical engine module base 22, an adjustment module 21, and a light valve (not shown). Please refer to FIG. 6, which illustrates a perspective view of the optical engine module base 22. The light valve is suitable for receiving the illumination beam L1 entering the optical engine module base 22 and converting the illumination beam L1 into an image beam L2. The light valve can be, for example, a Digital Micromirror Device (DMD), Liquid Crystal On Silicon panel (LCOS panel), or other reflective light modulators, transparent liquid crystal panels, Electro-Optical Modulators, Magneto-Optic modulators, Acousto-Optic Modulators (AOM), or other transmissive light modulators.

A light entry portion 221 of the optical engine module base 22 has a first side wall 222, a second side wall 223, and a light entry opening 224. The first side wall 222 and the second side wall 223 are substantially perpendicular to each other. The first side wall 222 has a first fixed portion 2221 and a first through hole 2222. The first fixed portion 2221 extends from the first side wall 222 away from the optical engine module base 22. The second side wall 223 has a second fixed portion 2231 and a second through hole 2232. The second fixed portion 2231 extends from the second side wall 223 away from the optical engine module base 22. The light entry opening 224 of the light entry portion 221 is located on the surface of the light entry portion 221 facing the adjustment module 21 and is positioned at the intersection of the first extension direction Y of the first through hole 2222 and the second extension direction X of the second through hole 2232. The light entry opening 224 is suitable for allowing the illumination beam L1 from the light source module 10 to pass through. The first extension direction Y and the second extension direction X are different directions. To clearly show the viewing angle of the perspective view, the third extension direction Z is further illustrated, wherein the first extension direction Y and the second extension direction X are perpendicular to each other in the illustration, and the third extension direction Z is perpendicular to both the first extension direction Y and the second extension direction X.

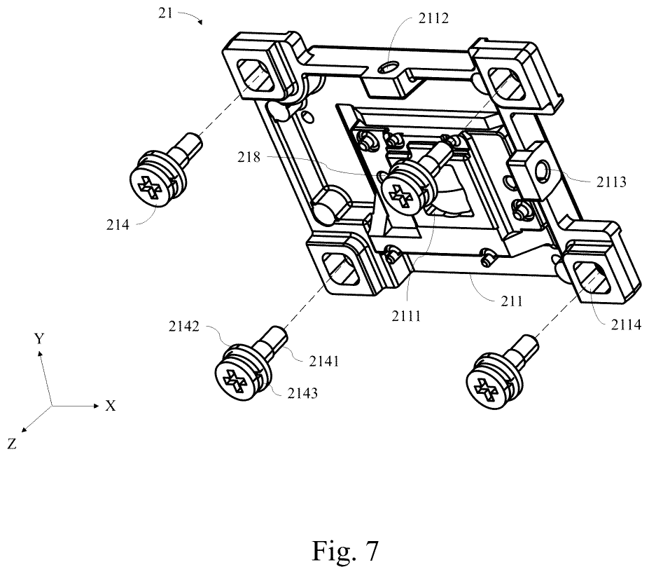

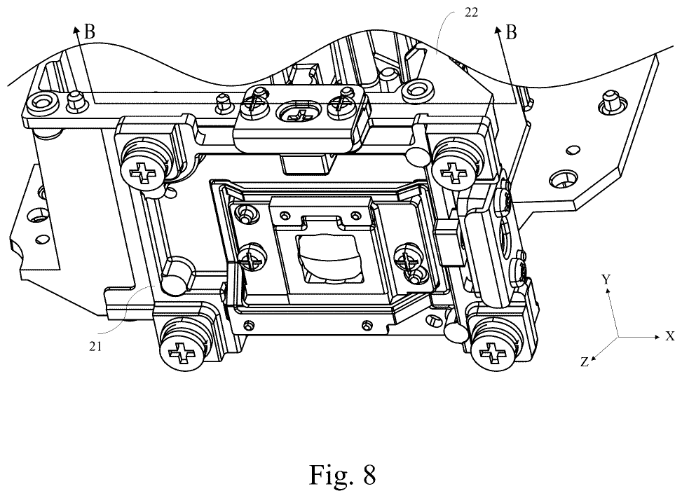

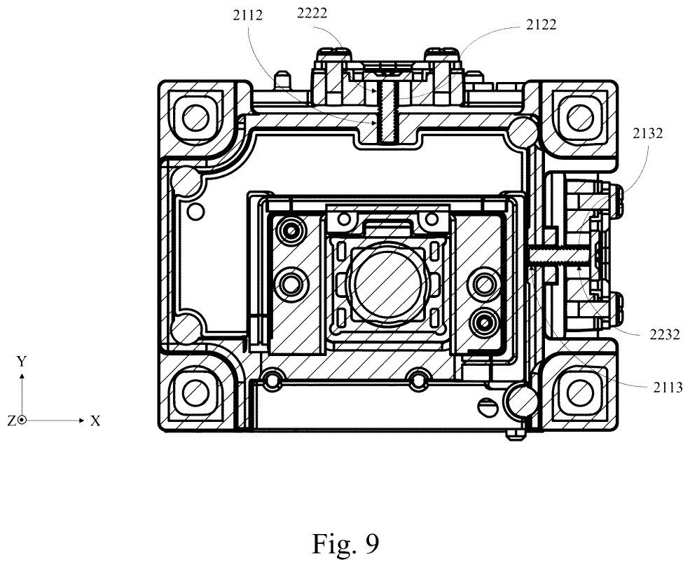

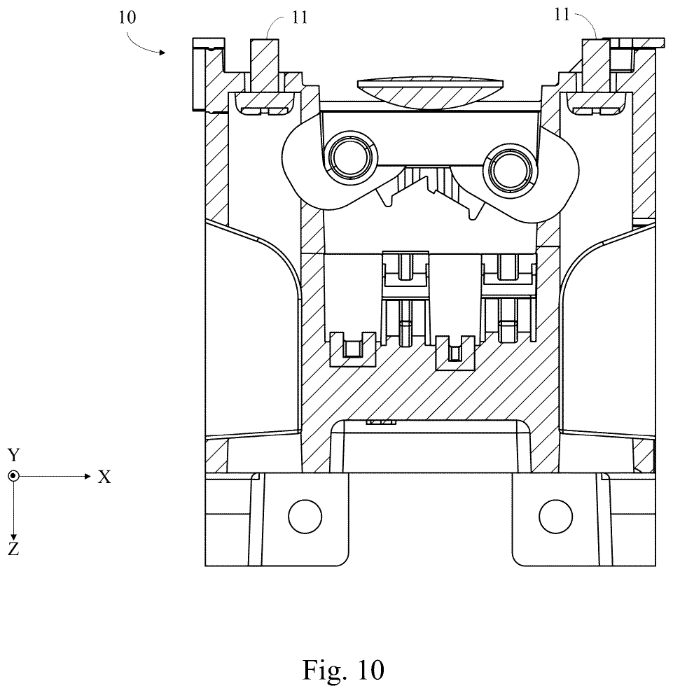

Please also refer to FIGS. 7 to 10 in conjunction with FIGS. 1 to 6. FIG. 7 illustrates a perspective view of the adjustment module 21. FIG. 8 illustrates a partial enlarged schematic view of the adjustment module 21 and the optical engine module base 22. FIG. 9 illustrates a cross-sectional view taken along line B-B of FIG. 8. FIG. 10 illustrates a cross-sectional view taken along line C-C of FIG. 5. The adjustment module 21 is located between the light source module 10 and the light entry portion 221 of the optical engine module base 22. The adjustment module 21 has a substrate 211, a first adjustment component 212, and a second adjustment component 213. The light source module 10 is fixed to the substrate 211 of the adjustment module 21. In the embodiment of FIG. 10, please also refer to FIGS. 5 and 7, the light source module 10 is fixed to the substrate 211 of the adjustment module 21 by a light source fixing element 11 through a locking through hole 218. The substrate 211 has a light transmission opening 2111, a first adjustment screw hole 2112, and a second adjustment screw hole 2113. The light transmission opening 2111 communicates with the light entry opening 224 of the optical engine module base 22, and the illumination beam L1 from the light source module 10 is suitable for sequentially passing through the light transmission opening 2111 and the light entry opening 224 and entering the optical engine module 20. The first adjustment screw hole 2112 is adjacent to the first side wall 222 and is located in the first extension direction Y of the first through hole 2222, and the second adjustment screw hole 2113 is adjacent to the second side wall 223 and is located in the second extension direction X of the second through hole 2232. The first extension direction Y is different from the second extension direction X. In this embodiment, the first extension direction Y is perpendicular to the second extension direction X.

The first adjustment component 212 is located in the first extension direction Y. The first adjustment component 212 covers the first fixed portion 2221. The first adjustment component 212 includes a first limit piece 2121 and a first adjustment element 2122. The first limit piece 2121 includes a first opening 2123. The first opening 2123 is located in the first extension direction Y of the first through hole 2222. The first adjustment element 2122 is inserted through the first through hole 2222 of the first side wall 222 and is screwed into the first adjustment screw hole 2112. A first head 21221 of the first adjustment element 2122 is rotatably positioned between the first limit piece 2121 and the first side wall 222. The first head 21221 is clamped between the first limit piece 2121 and the first side wall 222. The first opening 2123 of the first limit piece 2121 exposes the first head 21221. By clamping the first head 21221 with the first limit piece 2121, the first adjustment element 2122 does not move along the first extension direction Y when rotated in the first extension direction Y.

When the first adjustment element 2122 rotates clockwise, it screws into the first adjustment screw hole 2112 and moves the base 211 towards the first side wall 222. When the first adjustment element 2122 rotates counterclockwise, it unscrews from the first adjustment screw hole 2112, moving the base 211 away from the first side wall 222.

The second adjustment component 213 is positioned in the second extension direction X. The second adjustment component 213 covers the second fixed portion 2231. The second adjustment component 213 includes a second limit piece 2131 and a second adjustment element 2132. The second limit piece 2131 includes a second opening 2133. The second opening 2133 is located in the second extension direction X of the second through hole 2232. The second adjustment element 2132 passes through the second through hole 2232 of the second side wall 223 and threads with the second adjustment screw hole 2113. A second head 21321 of the second adjustment element 2132 is rotatably positioned between the second limit piece 2131 and the second side wall 223. The second head 21321 is clamped between the second limit piece 2131 and the second side wall 223. The second opening 2133 of the second limit piece 2131 exposes the second head 21321. By clamping the second head 21321 with the second limit piece 2131, the second adjustment element 2132 does not move along the second extension direction X when rotated in the second extension direction X.

When the second adjustment element 2132 rotates clockwise, it screws into the second adjustment screw hole 2113 and moves the base 211 towards the second side wall 223. When the second adjustment element 2132 rotates counterclockwise, it unscrews from the second adjustment screw hole 2113, moving the base 211 away from the second side wall 223.

Therefore, by rotating the first head 21221 of the first adjustment element 2122 through the first opening 2123 of the first adjustment component 212, the substrate 211 of the adjustment module 21 moves the light source module 10 in the first extension direction Y relative to the first adjustment element 2122. By rotating the second head 21321 of the second adjustment element 2132 through the second opening 2133 of the second adjustment component 213, the substrate 211 of the adjustment module 21 moves the light source module 10 in the second extension direction X relative to the second adjustment element 2132.

Based on the above, in the projection device 100 of the present application, the optical engine module 20 includes an optical engine module base 22 and an adjustment module 21. The adjustment module 21 moves the light source module 10 relative to the optical engine module base 22 via the first adjustment component 212 and the second adjustment component 213. This allows the light source module 10 and the optical engine module base 22 to be quickly and accurately aligned without being constrained by their structures, ensuring that the illumination beam L1 from the light source module 10 precisely passes through the light entry opening 224 of the optical engine module base 22. Additionally, since the alignment between the light source module 10 and the optical engine module base 22 can be achieved through the adjustment module 21, it significantly reduces the impact of part tolerances on the illumination beam L1, lowers the tolerance requirements for parts, and thereby reduces the cost of purchasing parts.

Please continue to refer to FIGS. 6 and 7. The adjustment module 21 of this embodiment also includes a fixing element 2141. The substrate 211 also includes adjustment limit holes 2114, located at the corners of the substrate 211. As shown in FIG. 7, in this embodiment, the adjustment limit holes 2114 are individually located at the four corners of the substrate 211. The fixing element 2141 passes through the adjustment limit holes 2114 and is secured to the optical engine module locking hole 225 of the optical engine module base 22.

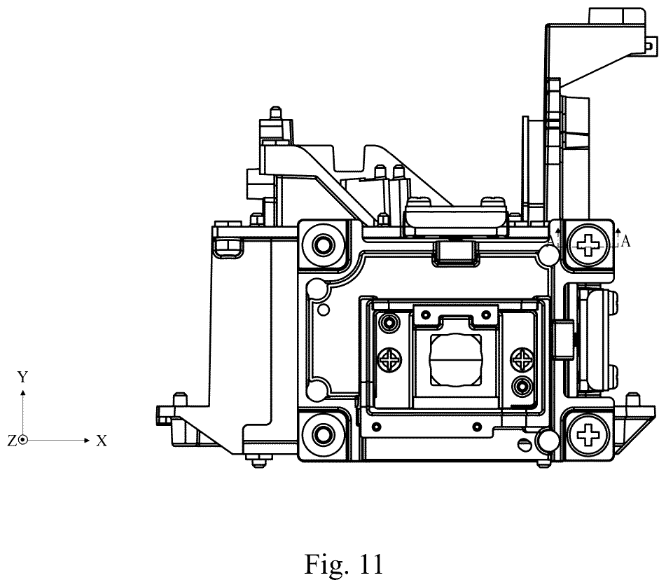

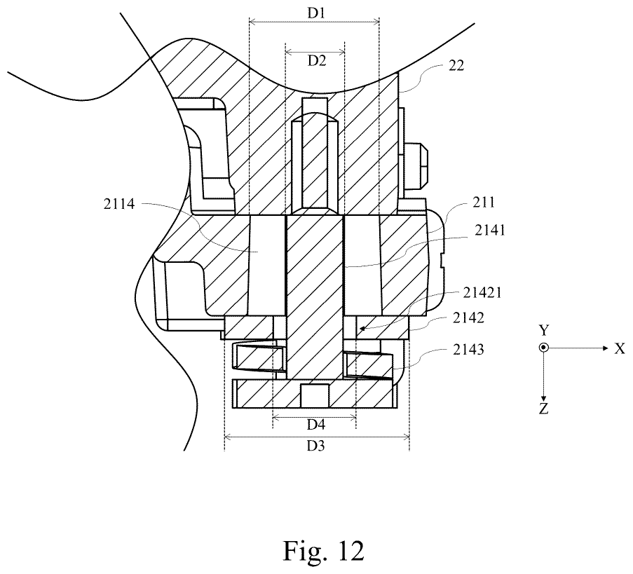

FIG. 11 illustrates another schematic view of FIG. 8 from a different angle. FIG. 12 illustrates a cross-sectional view taken along line A-A of FIG. 11. Please refer to FIGS. 7, 11, and 12 together. The adjustment module 21 of this embodiment also includes a fixing component 214. The fixing component 214 includes a protective piece 2142, an elastic piece 2143, and a fixing element 2141. The fixing element 2141 sequentially passes through the elastic piece 2143 and the protective piece 2142. The protective piece 2142 is arranged on the side of the adjustment limit hole 2114 away from the optical engine module base 22, and the elastic piece 2143 is arranged on the side of the protective piece 2142 away from the optical engine module base 22. The adjustment limit hole 2114 has an inner diameter D1. The fixing element 2141 has a diameter D2. The diameter D2 of the fixing element 2141 is smaller than the inner diameter D1 of the adjustment limit hole 2114. Thus, the fixing component 214 secures the fixing element 2141 to the optical engine module base 22 through the pressure of the elastic piece 2143 by friction, thereby fixing the adjustment module 21 to the optical engine module base 22. It should be additionally noted that FIG. 11 presents views with and without the fixing component 214 for reference.

The protective piece 2142 has an outer diameter D3, which is larger than the inner diameter D1 of the adjustment limit hole 2114. The protective piece 2142 has a through hole 21421, the diameter D4 of which is larger than the diameter D2 of the fixing element 2141. By making the diameter D4 of the through hole 21421 larger than the diameter D2 of the fixing element 2141 and the diameter D2 of the fixing element 2141 smaller than the inner diameter D1 of the adjustment limit hole 2114, there is a gap between the fixing element 2141 and the through hole 21421 and adjustment limit hole 2114. This gap allows the adjustment module 21 to move relative to the optical engine module base 22, providing the adjustment module 21 with space to move.

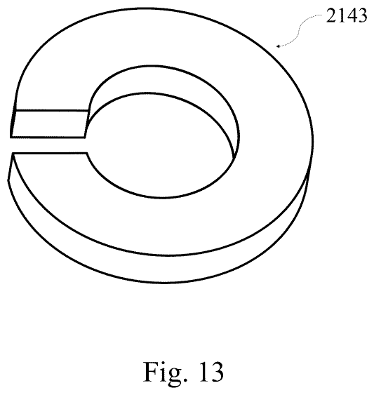

As shown in FIG. 7, in this embodiment, there are four adjustment limit holes 2114, and the number of fixing components 214 corresponds to the number of adjustment limit holes 2114, which is also four. These four adjustment limit holes 2114 are, for example, respectively located at the four corners of the substrate 211, but the present application is not limited to the number of adjustment limit holes 2114 and fixing components 214. In one embodiment, the elastic piece 2143 is a C-shaped spring, as shown in FIG. 13.

Please continue to refer to FIG. 6. The first adjustment component 212 of this embodiment also includes a first fixing element 2124. The first limit piece 2121 includes a first fixing hole 2125. The first fixing element 2124 passes through the first fixing hole 2125 and is secured to the first fixed portion 2221 of the optical engine module base 22. In this embodiment, there are two first fixing holes 2125, and the number of first fixing elements 2124 corresponds to the number of first fixing holes 2125, which is also two.

Please continue to refer to FIG. 6. The second adjustment component 213 of this embodiment also includes a second fixing element 2134. The second limit piece 2131 also includes a second fixing hole 2135. The second fixing element 2134 passes through the second fixing hole 2135 and is secured to the second fixed portion 2231 of the optical engine module base 22. In this embodiment, there are two second fixing holes 2135, and the number of second fixing elements 2134 corresponds to the number of second fixing holes 2135, which is also two.

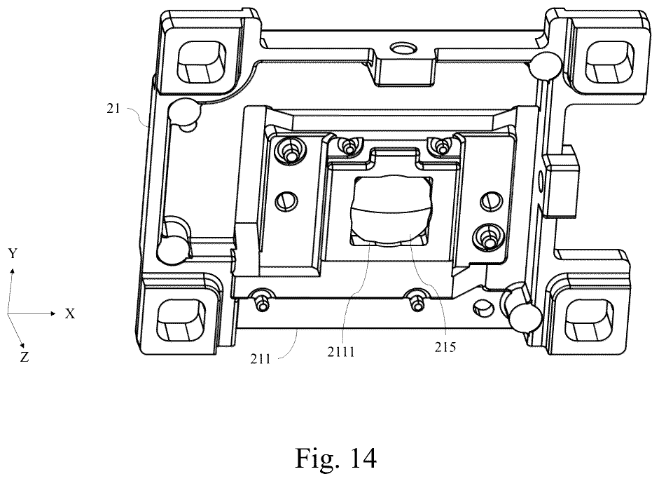

FIG. 14 is a schematic diagram of the adjustment module, which includes an optical component. In this embodiment, the adjustment module 21 also includes an optical component 215. The optical component 215 is located at the light transmission opening 2111 and covers it. As a result, the illumination beam L1 from the light source module 10 can pass through the optical component 215 and enter the light entry opening 224 of the optical engine module base 22, allowing the illumination beam L1 to enter the light intergration rod (not shown) of the optical engine module base 22. In one embodiment, the optical component 215 can be a lens or a diffusion sheet, though the present application is not limited to these examples.

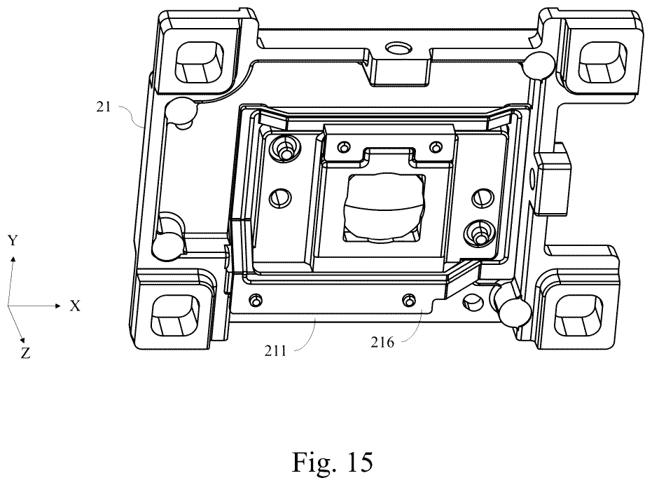

FIG. 15 is a schematic diagram of the adjustment module, which includes a light source dustproof piece. In this embodiment, the adjustment module 21 also includes a light source dustproof piece 216. The light source dustproof piece 216 is positioned between the substrate 211 and the light source module 10. It surrounds the light transmission opening 2111 and exposes the optical component 215 and the light transmission opening 2111.

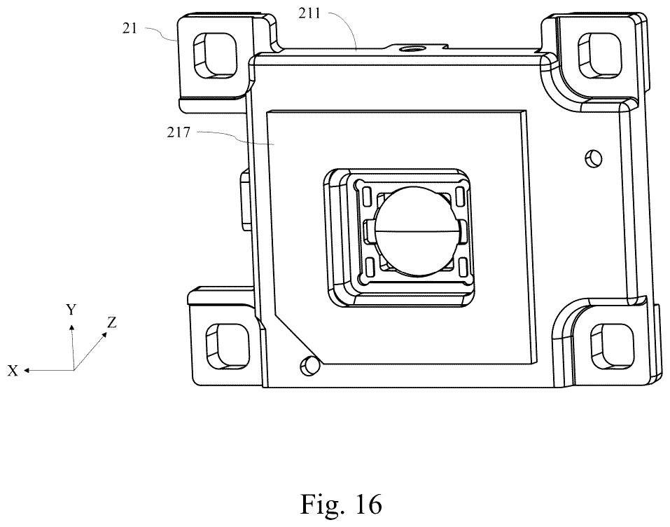

FIG. 16 illustrates another schematic view of the adjustment module, which includes an optical engine module dustproof piece. In this embodiment, the adjustment module 21 also includes an optical engine module dustproof piece 217. The optical engine module dustproof piece 217 is positioned between the substrate 211 and the optical engine module base 22. It surrounds the light transmission opening 2111 and exposes the optical component 215 and the light transmission opening 2111.

Therefore, in the present application, the substrate 211 placed between the light source module 10 and the optical engine module base 22, and the optical component 215 positioned on the substrate 211, enable the light source module 10 and the optical engine module 20 to each form their own separate cavities. Additionally, the light source dustproof piece 216 and the optical engine module dustproof piece 217 further enhance the dustproof effectiveness of the light source module 10 and the optical engine module 20.

Referring to FIG. 3 again, this embodiment of the projection device 100 also includes a colloid 23. The colloid 23 is applied to the substrate 211 of the adjustment module 21 and the optical engine module base 22 of the optical engine module 20, bonding the substrate 211 and the optical engine module base 22. This way, after aligning the adjustment module 21 with the optical engine module base 22, the substrate 211 and the optical engine module base 22 are fixed in place with the colloid 23.

Based on the above, the present application has at least one of the following advantages or effects. In the projection device of the present application, the optical engine module includes an optical engine module base and an adjustment module. The adjustment module drives the light source module to move relative to the optical engine module. Meanwhile, a sensor is used to instantly confirm whether the lumen value of the illumination beam has reached the set value, indicating that the light source module and the optical engine module are aligned when the set value is reached during alignment. Therefore, during the alignment process, adjusting the adjustment module can move the light source module relative to the optical engine module, allowing for quick and accurate alignment without being constrained by their structures. Moreover, because the alignment between the light source module and the optical engine module can be achieved by the adjustment module, the impact of part tolerances on the illumination beam is significantly reduced, the requirements for part tolerances are lowered, and consequently, the cost of purchasing parts is reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A projection device, comprising:
a light source module, configured to providing an illumination beam;
an optical engine module, configured to receiving the illumination beam and comprising an optical engine module base and an adjustment module; the optical engine module is adapted to convert the illumination beam into an image beam; wherein:
a light entry portion of the optical engine module base has a first wall and a second side wall substantially perpendicular to each other; the first side wall has a first through hole, and the second side wall has a second through hole; a light entry opening of the light entry portion is located at an intersection of a first extension direction of the first through hole and a second extension direction of the second through hole; the light entry opening allows the illumination beam from the light source module to pass through;
the adjustment module is located between the light source module and the light entry portion of the optical engine module base; the adjustment module comprises a substrate, a first adjustment component, and a second adjustment component; the light source module is fixed to the substrate of the adjustment module, the substrate has a light transmission opening, a first adjustment screw hole, and a second adjustment screw hole; the light transmission opening communicates with the light entry port, the illumination beam from the light source module sequentially passes through the light transmission opening and the light entry opening; and
the first adjustment screw hole is adjacent to the first side wall and located in the first extension direction of the first through hole, and the second adjustment screw hole is adjacent to the second side wall and located in the second extension direction of the second through hole; the first extension direction is different from the second extension direction; wherein:
the first adjustment component comprises a first limit piece and a first adjustment element; the first limit piece has a first opening located in the first extension direction of the first through hole, the first adjustment element is inserted into the first through hole of the first side wall and threaded into the first adjustment screw hole; and
the second adjustment component comprises a second limit piece and a second adjustment element, the second limit piece has a second opening located in the second extension direction of the second through hole, the second adjustment element is inserted into the second through hole of the second side wall and threaded into the second adjustment screw hole; and
a projection lens, located in a transmission path of the image beam from the optical engine module.

2. The projection device as claimed in claim 1, wherein the first adjustment component further comprises a first head of the first adjustment element is rotatably positioned between the first limit piece and the first side wall, the first head is exposed through the first opening of the first limit piece, the second adjustment component further comprises a second head of the second adjustment element is rotatably positioned between the second limit piece and the second side wall, the second head is exposed through the second opening of the second limit piece, and he first head of the first adjustment element is configured to rotated through the first opening to allow the substrate to drive the light source module to move relative to the first adjustment element in the first extension direction, and the second head of the second adjustment element is configured to rotated through the second opening to allow the substrate to drive the light source module to move relative to the second adjustment component in the second extension direction.

3. The projection device as claimed in claim 1, wherein the adjustment module comprises a fixing element, the substrate further comprises an adjustment limit hole located at a corner of the substrate, and the fixing element passes through the adjustment limit hole and secures to the optical engine module base.

4. The projection device as claimed in claim 3, wherein the adjustment module includes a fixing component, the fixing component comprises a protective piece, an elastic piece, and the fixing element, wherein:
the protective piece is positioned on one side of the adjustment limit hole, away from the optical engine module base;
the elastic piece is positioned on one side of the protective piece, away from the optical engine module base; and
the fixing element passes through the elastic piece and the protective piece sequentially;
wherein, a diameter of the fixing element is smaller than an inner diameter of the adjustment limit hole.

5. The projection device as claimed in claim 4, wherein an outer diameter of the protective piece is greater than the inner diameter of the adjustment limit hole.

6. The projection device as claimed in claim 5, wherein the protective piece has a through hole, wherein a diameter of the through hole is greater than the diameter of the fixing element.

7. The projection device as claimed in claim 3, the number of adjustment limit holes is four, and the number of fixing components corresponds to the number of adjustment limit holes, which is also four.

8. The projection device as claimed in claim 1, wherein the first adjustment component further comprises a first fixing element, the first limit piece comprises a first fixing hole, the first fixing element passes through the first fixing hole and is secured to the optical engine module base.

9. The projection device as claimed in claim 8, the number of first fixing holes is two, corresponding to the number of first fixing elements, which is also two.

10. The projection device as claimed in claim 1, wherein the first adjustment element does not move along the first extension direction when rotated.

11. The projection device as claimed in claim 10, wherein when the first adjustment element rotates clockwise, the first adjustment element moves the base toward the first side wall; when the first adjustment element rotates counterclockwise, the first adjustment element moves the base away from the first side wall.

12. The projection device as claimed in claim 1, wherein the second adjustment component further comprises a second fixing element, and the second limit piece further comprises a second fixing hole; the second fixing element passes through the second fixing hole and is secured to the optical engine module base.

13. The projection device as claimed in claim 12, the number of second fixing holes is two, corresponding to the number of second fixing elements, which is also two.

14. The projection device as claimed in claim 1, wherein the second adjustment element does not move along the second extension direction when rotated.

15. The projection device as claimed in claim 14, wherein when the second adjustment element rotates clockwise, the second adjustment element moves the base toward the second side wall; when the second adjustment element rotates counterclockwise, the second adjustment element moves the base away from the second side wall.

16. The projection device as claimed in claim 1, wherein the adjustment module comprises an optical component that covers the light transmission opening.

17. The projection device as claimed in claim 1, wherein the adjustment module comprises a light source dustproof piece positioned between the substrate and the light source module.

18. The projection device as claimed in claim 1, wherein the adjustment module comprises an optical engine module dustproof piece positioned between the substrate and the optical engine module.

19. The projection device as claimed in claim 1, further comprising a colloid, wherein the colloid bonds the substrate and the optical engine module together.

20. A adjustment module, configured at a light entry portion of an optical engine module base, wherein the light entry portion comprises a first side wall and a second side wall that are substantially perpendicular to each other, the first side wall has a first through hole, and the second side wall has a second through hole, a light entry opening of the light entry portion is located at an intersection of a first extension direction of the first through hole and a second extension direction of the second through hole, the adjustment module comprising:
a substrate, comprising a light transmission opening, a first adjustment screw hole, and a second adjustment screw hole; wherein the light transmission opening communicates with the light entry opening; the first adjustment screw hole is adjacent to the first side wall and is located in the first extension direction of the first through hole, while the second adjustment screw hole is adjacent to the second side wall and is located in the second extension direction of the second through hole, the first extension direction is different from the second extension direction;
a first adjustment component, comprising a first limit piece and a first adjustment element; wherein the first limit piece has a first opening located in the first extension direction of the first through hole, the first adjustment element passes through the first through hole in the first side wall and threads with the first adjustment screw hole, and
a second adjustment component, comprising a second limit piece and a second adjustment element; wherein the second limit piece has a second opening, which is located in the second extension direction of the second through hole, the second adjustment element passes through the second through hole in the second side wall and threads with the second adjustment screw hole.

21. The adjustment module as claimed in claim 20, wherein the first adjustment component further comprises a first head of the first adjustment element is rotatably positioned between the first limit piece and the first side wall, the first head is exposed through the first opening of the first limit piece, the second adjustment component further comprises a second head of the second adjustment element is rotatably positioned between the second limit piece and the second side wall, the second head is exposed through the second opening of the second limit piece, and the first head of the first adjustment element is configured to be rotated through the first opening, the substrate moves in the first extension direction relative to the first adjustment element, and the second head of the second adjustment element is configured to be rotated through the second opening, the substrate moves in the second extension direction relative to the second adjustment element.

22. An optical engine module, for receiving an illumination beam and comprising:
an optical engine module base, wherein a light entry portion of the optical engine module base has a first side wall and a second side wall that are substantially perpendicular to each other, the first side wall has a first through hole, and the second side wall has a second through hole, the light entry opening of the light entry portion is located at an intersection of the first extension direction of the first through hole and the second extension direction of the second through hole; and
an adjustment module, configured in the light entry portion and comprising a substrate, a first adjustment component, and a second adjustment component; wherein the substrate has a light transmission opening, a first adjustment screw hole, and a second adjustment screw hole, the light transmission opening communicates with the light entry opening, the first adjustment screw hole is adjacent to the first side wall and located in the first extension direction of the first through hole, the second adjustment screw hole is adjacent to the second side wall and located in the second extension direction of the second through hole, wherein the first extension direction differs from the second extension direction; wherein:
the first adjustment component comprises a first limit piece and a first adjustment element, the first limit piece has a first opening located in the first extension direction of the first through hole, the first adjustment element passes through the first through hole of the first side wall and threads with the first adjustment screw hole; and
the second adjustment component comprises a second limit piece and a second adjustment element, the second limit piece has a second opening located in the second extension direction of the second through hole, the second adjustment element passes through the second through hole of the second side wall and threads with the second adjustment screw hole.
